(19) United States
(12) Patent Application Publication
(10) Pub. No.: US 2023/0411898 A1
(43) Pub. Date: Dec. 21, 2023

(54) CONNECTOR HAVING FIRST CONTACT ELEMENTS AND SECOND CONTACT ELEMENTS WHICH ARE CONNECTED TO EACH OTHER TO ESTABLISH AN ELECTRICAL CONNECTION, AND HAVING A CASTING RESIN WHICH AT LEAST PARTIALLY SURROUNDS THE CONTACT ELEMENTS

(71) Applicant: HELLA GmbH & Co. KGaA, Lippstadt (DE)

(72) Inventors: Christopher KLUEPPEL, Lippstadt-Lipperode (DE); Stefan PETERS, Lippstadt (DE)

(73) Assignee: HELLA GmbH & Co. KGaA, Lippstadt (DE)

(21) Appl. No.: 18/234,215

(22) Filed: Aug. 15, 2023

Related U.S. Application Data
(63) Continuation of application No. PCT/EP2022/053261, filed on Feb. 10, 2022.

(30) Foreign Application Priority Data
Feb. 15, 2021 (DE) 10 2021 103 474.4

(51) Int. Cl. H01R 13/506; H01R 13/405; H01R 13/52

(52) U.S. Cl. CPC H01R 13/506; H01R 13/405; H01R 13/5216

(57) ABSTRACT

A connector having a housing, having first contact elements and second contact elements that are connected to one another and arranged in the housing in order to establish an electrical connection, having first lines that are connected to the first contact elements, having second lines that are connected to the second contact elements or whose ends form the second contact elements, and having a casting resin that at least partially surrounds the contact elements, but surrounds at least the contact points between the first and the second contact elements The housing is formed of multiple parts, and has at least a first housing part and a second housing part that are connected to one another. The contact points are provided in or on the first housing part, and the casting resin has a connection to the first housing part.

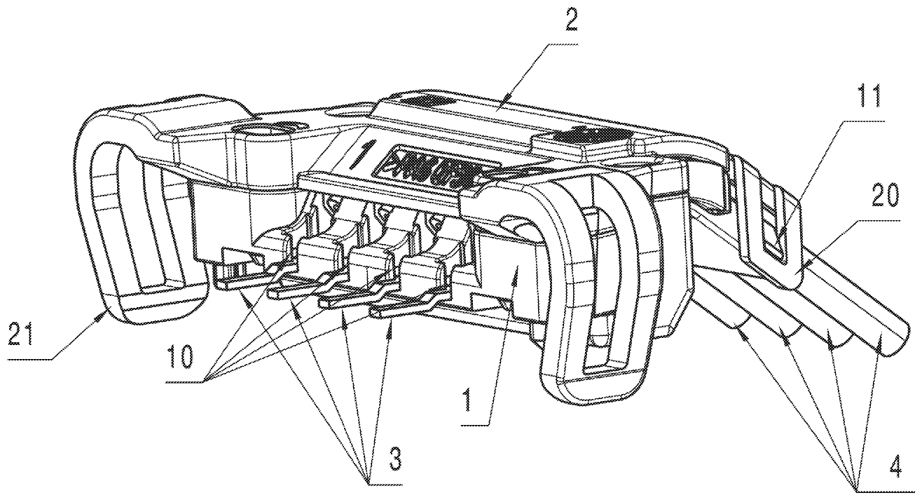

This nonprovisional application is a continuation of International Application No. PCT/EP2022/053261, which was filed on Feb. 10, 2022, and which claims priority to German Patent Application No. 10 2021 103 474.4, which was filed in Germany on Feb. 15, 2021, and which are both herein incorporated by reference.

### BACKGROUND OF THE INVENTION

### Field of the Invention

The present invention relates to a connector having a housing, having first contact elements and second contact elements that are connected to one another and arranged in the housing in order to establish an electrical connection, having first lines that are connected to the first contact elements, having second lines that are connected to the second contact elements or whose ends form the second contact elements, and having a casting resin that at least partially surrounds the contact elements, but surrounds at least the contact points between the first and the second contact elements.

### Description of the Background Art

With a connector, a permanent electrical connection can be established between a cable and an electrical or electronic assembly, for example. The first contact elements can be provided on the assembly side. The second contact elements can be formed by ends of conductors of the cable that are soldered to the first contact elements. Since the connection may be exposed to a damp and/or aggressive environment, the housing in which the electrical connection is established between the first contact elements and the second contact elements is potted with a casting resin. The casting resin surrounds the contact points and protects them from the ambient atmosphere.

For some applications of such connector, it is helpful when the housing has certain properties that depend upon the material from which the housing is made. In addition to the desired, advantageous properties, the material from which the housing is made then also sometimes has other properties that are not advantageous. It is thus possible, for example, that the housing should have elastic connecting elements such as snap hooks or the like in order to be able to attach the housing to the electrical or electronic assembly. If an elastic plastic is then used for the housing, the plastic may have properties that are detrimental to a connection between the casting resin and the housing. For instance, a typical casting resin generally has a different coefficient of thermal expansion than an elastic plastic. This can cause the casting resin to separate from the housing, especially in the event of frequent temperature fluctuations, making it possible for moisture to enter the connector and degrade the operational reliability of the connector.

### SUMMARY OF THE INVENTION

It is therefore an object of the present invention to providing a connector such that properties of the housing can be chosen as freely as possible, on the one hand, and the properties of the housing that are desired for an encapsulation of the contact point can be preserved, on the other hand.

This object is attained in an example according to the invention in that the housing is formed of multiple parts, and has at least a first housing part and a second housing part that are connected to one another, the contact points are provided in or on the first housing part, and the casting resin has a connection to the first housing part.

Owing to the multipart housing according to the invention formed of at least the first and the second housing parts, it is possible to obtain different material properties on or in a housing.

The first housing part can, for example, be made of a first material that is suitable for an especially good connection to the casting resin, for example. The second housing part can then be made of a second material that is especially suitable, for example, for connecting the second housing part to the first housing part and/or for connecting the housing to other parts.

The first material, from which the first housing part is made, can have, for example, a coefficient of thermal expansion that is equal or nearly equal to a coefficient of thermal expansion of the casting resin. As a result, it is possible to avoid stresses at the connection points between the first housing part and the casting resin that are great enough to cause the connection between casting resin and the housing to separate when temperature fluctuations occur.

The second housing part can, according to the invention, be made of a second material that has a modulus of elasticity that is lower than the modulus of elasticity of the first material. The second material can thus be more elastic than the first material. The second housing part can, for example, have connecting elements, in particular snap hooks, that are elastically deformable to establish the connection of the second housing part to the first housing part and/or to another object.

The connector can include a printed circuit board. The first contact elements can be attached to the printed circuit board and the first lines can be designed as conductive traces on the printed circuit board. A connection point or connection points between the first contact elements and the first lines can also be surrounded by the casting resin.

The first material can be a thermoset. The second material can be a thermoplastic.

The connector can be a part of an electrical or electronic assembly.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE is a perspective view of a housing and of first contact elements in the housing of a first connector and cables.

### DETAILED DESCRIPTION

The connector according to the invention, which is only partially shown in the FIGURE, has a housing 1, 2 with a first housing part 1 and a second housing part 2. Arranged in the first housing part 1 are first contact elements 3. For this purpose, the first housing part 1 has slots 10, in which the first contact elements are placed. The connector is connected to cables 4. These cables 4 have conductors whose ends form second contact elements, which are likewise inserted in the slots 10. The first contact elements 3 and the second contact elements are electrically connected to one another by soldering. The first contact elements 3 are arranged on a printed circuit board (not shown), where they are electrically connected to conductive traces that are provided on the printed circuit board and that can be part of an electrical circuit arrangement.

In the connector according to the invention, both the contact points between the first and the second contact elements and the contact points between the first contact elements and the conductive traces are insulated from the environment by a casting resin (not shown). For this purpose, the casting resin enters into a permanent connection with the printed circuit board and the first housing part 1, so that no moisture, and also no gas, can penetrate to the contact points.

The first housing part 1 has detent projections 11 that interact with first snap hooks or locking hooks 20 of the second housing part 2 so that the two housing parts 1, 2 are permanently connected to one another by a latching connection.

The second housing part 2 has additional snap or locking hooks 21. They can serve to connect the housing, and thus the connector as a whole, to other parts, for example to other parts of an electrical or electronic assembly, of which the connector can be a part.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A connector comprising:
a housing;
first contact elements and second contact elements that are connected to one another and arranged in the housing in order to establish an electrical connection;
first lines that are connected to the first contact elements;
second lines that are connected to the second contact elements or whose ends form the second contact elements; and
a casting resin that at least partially surrounds the contact elements and surrounds at least the contact points between the first and the second contact elements
wherein the housing is formed of multiple parts, and has at least a first housing part and a second housing part that are connected to one another,
wherein the contact points are provided in or on the first housing part, and
wherein the casting resin has a connection to the first housing part.

2. The connector according to claim 1, wherein the casting resin has a coefficient of thermal expansion that is equal or nearly equal to a coefficient of thermal expansion of a first material from which the first housing part is made.

3. The connector according to claim 1, wherein the second housing part is made of a second material that has a modulus of elasticity that is lower than the modulus of elasticity of the first material.

4. The connector according to claim 3, wherein the second housing part has connecting elements or snap hooks that are elastically deformable to establish the connection of the second housing part to the first housing part and/or to another object.

5. The connector according to claim 1, wherein the connector includes a printed circuit board, and wherein the first contact elements are attached to the printed circuit board and the first lines are designed as conductive traces on the printed circuit board.

6. The connector according to claim 5, wherein a connection point or connection points between the first contact elements and the first lines is surrounded by the casting resin.
